(19) United States
(12) Patent Application Publication
(10) Pub. No.: US 2026/0137970 A1
(43) Pub. Date: May 21, 2026

(54) FLAME-RETARDANT ASSEMBLY FOR BATTERY AND BATTERY ASSEMBLY INCLUDING THE SAME

(71) Applicant: SK On Co., Ltd., Seoul (KR)

(72) Inventors: Won Gab HWANG, Daejeon (KR); Chae Won NA, Daejeon (KR); Gang U LEE, Daejeon (KR); Kyu Hyun HAN, Daejeon (KR)

(21) Appl. No.: 19/390,674

(22) Filed: Nov. 17, 2025

(30) Foreign Application Priority Data
Nov. 19, 2024 (KR) 10-2024-0165308

(51) Int. Cl. A62C 35/10; A62C 3/16; H01M 10/658; H01M 50/242; H01M 50/291; H01M 50/293; H01M 50/505

(52) U.S. Cl. CPC A62C 35/10; A62C 3/16; H01M 50/242; H01M 50/291; H01M 50/293; H01M 50/505; H01M 10/658; H01M 2200/10

(57) ABSTRACT

The present disclosure relates to a flame-retardant assembly for a battery, comprising a flame-retardant member including an elastic material and formed to have a predetermined first volume, and a housing configured to receive the flame-retardant member by compressing the flame-retardant member to a predetermined second volume smaller than the first volume. In addition, the present disclosure relates to a battery assembly comprising a plurality of battery cells, a receiving case configured to receive the plurality of battery cells, an insertion space formed between the plurality of battery cells and the receiving case, and the flame-retardant assembly disposed in the insertion space.

### CROSS-REFERENCE TO RELATED PATENT APPLICATION

The present application claims priority under 35 U.S.C. § 119(a) to Korean patent application number 10-2024-0165308 filed on Nov. 19, 2024, in the Korean Intellectual Property Office, the entire disclosure of which is incorporated by reference herein.

### BACKGROUND OF THE INVENTION

### 1. Field

The present disclosure relates to a flame-retardant assembly for a battery and a battery assembly including the same. More specifically, the present disclosure relates to a flame-retardant assembly for a battery having improved thermal stability and a battery assembly including the same.

### 2. Description of the Related Art

Recently, due to fires or explosions occurring during the use of lithium secondary batteries, social concerns about the safety of battery use have been increasing. Based on such social concerns, one of the major development tasks of recent lithium secondary batteries is to eliminate instability such as fire or explosion caused by thermal runaway of a battery cell.

In particular, in a battery module or pack, there exists an empty space other than the battery cells serving as energy sources. If a fire occurs due to an external impact or a problem of a battery cell, flames may spread to adjacent cells through the empty space, thereby increasing damage caused by the fire. Such a risk of fire can become a major obstacle to the electric vehicle market, and thus, methods capable of reducing the propagation of fire have been continuously studied.

### SUMMARY OF THE INVENTION

First, according to one aspect of the present disclosure, the problem to be solved is to delay (mitigate) or block thermal propagation (TP), in which high-temperature gas generated from a battery cell where thermal runaway occurs among one or more battery cells provided inside a battery assembly propagates to an adjacent battery cell.

Second, according to another aspect of the present disclosure, the problem to be solved is to allow high-temperature gas generated from a battery cell where thermal runaway occurs to be vented along an intended path.

Third, according to still another aspect of the present disclosure, the problem to be solved is to increase heat resistance or fire resistance to enhance the thermal stability of the battery assembly.

Fourth, according to yet another aspect of the present disclosure, the problem to be solved is to improve the manufacturing efficiency of the battery assembly.

Meanwhile, the present disclosure can be widely applied to fields of green technology such as electric vehicles (EVs), battery charging stations, energy storage systems (ESSs), photovoltaics, and wind power using batteries. In addition, the present disclosure can be used for eco-friendly mobility, including electric vehicles and hybrid vehicles, to suppress air pollution and greenhouse gas emissions and prevent climate change.

As a technical means to achieve the technical objects, a flame-retardant assembly for a battery according to the present disclosure may comprise: a flame-retardant member comprising an elastic material and formed to have a predetermined first volume; and a housing configured to receive the flame-retardant member by compressing the flame-retardant member to a predetermined second volume smaller than the first volume.

In one embodiment, a volume of the flame-retardant member may increase to a third volume greater than the second volume when the housing is melted at a predetermined temperature or higher.

In one embodiment, the housing may comprise a heat-shrinkable polymer.

In one embodiment, the flame-retardant member may comprise any one selected from a silicone polymer, polyurethane, or epoxy, or a combination thereof.

In one embodiment, the flame-retardant member may comprise a plurality of flame-retardant bodies, and a total volume of the plurality of flame-retardant bodies may be compressed to be equal to or less than the second volume by the housing and received in the housing.

Meanwhile, a battery assembly according to the present disclosure may comprise: a plurality of battery cells; a receiving case configured to receive the plurality of battery cells; an insertion space formed between the plurality of battery cells and the receiving case; and a flame-retardant assembly disposed in the insertion space, the flame-retardant assembly comprising a flame-retardant member including an elastic material and formed to have a predetermined first volume, and a housing configured to receive the flame-retardant member by compressing the flame-retardant member to a predetermined second volume smaller than the first volume.

In one embodiment, the flame-retardant member may increase to a third volume greater than the second volume when the housing is melted at a predetermined temperature or higher.

In one embodiment, the battery assembly may further comprise a busbar electrically connected to the plurality of battery cells, and the insertion space may be located between the plurality of battery cells and the busbar.

In one embodiment, the battery assembly according to the present disclosure may further comprise a busbar frame configured to support the busbar between the plurality of battery cells and the busbar, and the insertion space may be located between the plurality of battery cells and the busbar frame.

In one embodiment, each of the plurality of battery cells may comprise: an electrode assembly; a cell case configured to receive the electrode assembly therein; and a terminal portion electrically connected to the electrode assembly and protruding outward from the cell case, and the insertion space may be divided into a plurality of separated spaces by the terminal portions of the plurality of battery cells.

In one embodiment, the battery assembly according to the present disclosure may further comprise a busbar frame disposed to face the respective cell cases of the plurality of battery cells along a stacking direction of the plurality of battery cells, and a busbar supported by the busbar frame and electrically connected to the respective terminal portions of the plurality of battery cells through the busbar frame, and each of the plurality of separated spaces may be formed by the busbar frame, the respective terminal portions, and the respective cell cases of the plurality of battery cells.

In one embodiment, a plurality of the flame-retardant assemblies may be provided, and the plurality of flame-retardant assemblies may be disposed in at least a part of the plurality of separated spaces.

In one embodiment, a volume of a flame-retardant member of any one of the plurality of flame-retardant assemblies may increase to a third volume equal to a volume of any one of the separated spaces in which the corresponding flame-retardant assembly is disposed when a housing of the corresponding flame-retardant assembly is melted at a predetermined temperature or higher.

In one embodiment, the receiving case may comprise: a body bottom side forming a bottom surface of the receiving case; and a first body side and a second body side extending from the body bottom side, disposed to face each other with the plurality of battery cells interposed therebetween along a stacking direction of the plurality of battery cells, and forming both side surfaces of the receiving case, and the insertion space may comprise a first insertion space formed between the plurality of battery cells and the first body side, and a second insertion space formed between the plurality of battery cells and the second body side.

In one embodiment, each of the plurality of battery cells may comprise: an electrode assembly; a cell case configured to receive the electrode assembly therein; a first terminal portion electrically connected to the electrode assembly and protruding from the cell case toward the first body side; and a second terminal portion electrically connected to the electrode assembly and protruding from the cell case toward the second body side, and the first insertion space and the second insertion space may be respectively divided into a plurality of separated spaces by the first terminal portions and the second terminal portions of the plurality of battery cells.

First, according to one embodiment of the present disclosure, thermal propagation (TP), in which high-temperature gas generated from a battery cell where thermal runaway occurs among one or more battery cells provided inside a battery assembly, such as a battery module or a battery pack, propagates to an adjacent battery cell, can be delayed (mitigated) or blocked.

Second, according to another embodiment of the present disclosure, high-temperature gas generated from a battery cell where thermal runaway occurs can be vented along an intended path.

Third, according to still another embodiment of the present disclosure, heat resistance or fire resistance can be increased to enhance the thermal stability of the battery assembly.

Fourth, according to yet another embodiment of the present disclosure, the manufacturing efficiency of the battery assembly can be improved.

### BRIEF DESCRIPTION OF THE DRAWINGS

FIG. 1 is an example of a battery assembly according to the present disclosure.

FIG. 2 is an exploded view of an example of the battery assembly according to the present disclosure.

FIG. 3 is a top view of the battery assembly according to the present disclosure.

FIG. 4 schematically illustrates an example of a flame-retardant assembly received in an insertion space.

FIG. 5 schematically illustrates another example of a flame-retardant assembly received in an insertion space.

FIG. 6 illustrates a volume change of an example of the flame-retardant assembly.

FIG. 7 illustrates a volume change of the flame-retardant assembly received in a separated space after melting of the housing at a predetermined temperature or higher.

FIG. 8 illustrates a volume change of another example of the flame-retardant assembly.

FIG. 9 illustrates another example of the battery assembly according to the present disclosure.

### DETAILED DESCRIPTION

Hereinafter, preferred embodiments of the present disclosure will be described in detail with reference to the accompanying drawings.

A battery assembly 200, 300 according to the present disclosure is a concept collectively referring to a battery module, a battery pack, and an energy storage system (ESS). Therefore, the battery assembly 200, 300 according to the present disclosure may refer not only to a battery module but also to a battery pack or an energy storage system (ESS) that receives battery cells without a separate battery assembly, such as a cell-to-pack (CTP) structure.

In the present disclosure, unless otherwise explicitly stated, the term “flame-retardant assembly” or “flame-retardant assembly for a battery” refers to the flame-retardant assembly for a battery.

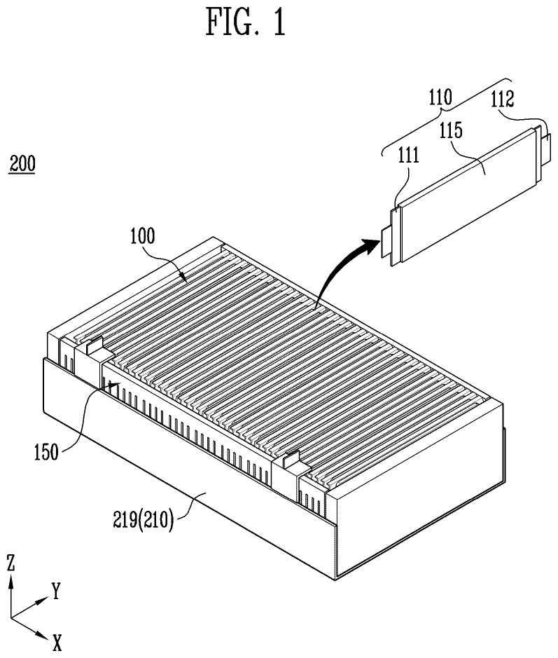

FIG. 1 is an example of a battery assembly 200 according to the present disclosure.

Referring to FIG. 1, the battery assembly 200 may include a plurality of battery cells 110, a busbar assembly 130 configured to electrically connect and support the plurality of battery cells 110, and a receiving case 210 configured to receive the plurality of battery cells 110.

Meanwhile, each of the plurality of battery cells 110 may include a cell case 115 including an electrode assembly 11 that generates or stores electrical energy, and terminal portions 111 and 112 protruding outward from the cell case 115.

The cell case 115 further includes an electrolyte (not shown) in contact with the electrode assembly 11. The electrolyte may be either liquid or solid. In addition, when the electrolyte is liquid, the electrode assembly may further include a separator for separating a positive electrode and a negative electrode.

Referring to FIG. 1, for example, the cell case 115 may be in the form of a pouch sealed with a film-type housing material. However, the form of the battery cell 110 according to the present disclosure is not limited thereto. For example, the battery cell 110 according to the present disclosure may be a prismatic or cylindrical battery cell.

Specifically, the terminal portions 111 and 112 may include a first terminal portion 111 and a second terminal portion 112 protruding from both side surfaces of the cell case 115 in directions away from the cell case 115.

Alternatively, the terminal portions 111 and 112 may be configured to protrude in the same direction.

Meanwhile, the receiving case 210 may be provided to protect the plurality of battery cells 110 from external impacts such as vibration. The receiving case 210 may include a receiving body 219 forming a part of a receiving space 280 that receives the plurality of battery cells 110, which will be described later.

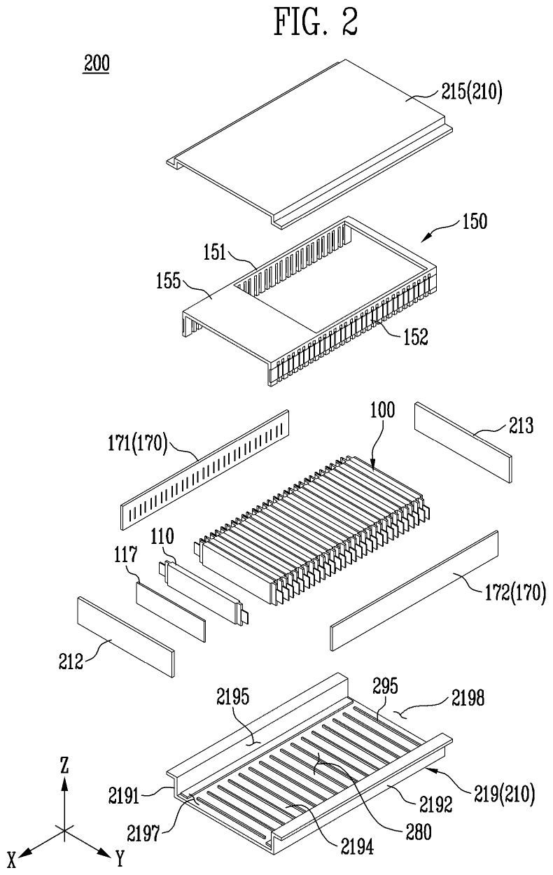

The busbar assembly 130 may include a busbar 170 (see FIG. 2) electrically connected to the plurality of battery cells 110, and a busbar frame 150 (see FIG. 2) positioned between the busbar 170 and the plurality of battery cells 110, configured to support the busbar 170, and into which the respective terminal portions 111 and 112 of the plurality of battery cells 110 are inserted.

An assembled structure in which the busbar assembly 130 or the busbar 170 is assembled with the plurality of battery cells 110 may be referred to as a battery cell stack 100.

FIG. 2 is an exploded view of an example of the battery assembly 200 according to the present disclosure.

Referring to FIG. 2, the receiving case 210 may include a receiving body 219 forming a part of a receiving space 280 that receives the battery cell stack 100, and a receiving cover 215 coupled to the receiving body 219 to together form the receiving space 280.

Inside the receiving body 219, the plurality of battery cells 110 may be positioned to overlap each other along a predetermined stacking direction (for example, the X-direction).

More specifically, the receiving case 210 may include an opening 2195 formed on one side, a receiving body 219 forming the receiving space 280, and a receiving cover 211 coupled to the receiving body 219 to together form the receiving space 280 and cover the opening 2195.

For example, the opening 2195 may be formed on an upper surface of the receiving case 210, but is not limited thereto.

The receiving cover 211 may be coupled to the receiving body 219 to close the opening 2195 and form the receiving space 280 together with the receiving body 219.

The receiving space 280 may receive the battery cell stack 100, and a part of the receiving space 280 may form an insertion space 288, which will be described later.

Meanwhile, the receiving body 219 may have a channel shape or a U-shape with an open upper portion. Referring to FIG. 2, both side surfaces 2197 and 2198 of the receiving body 219 facing each other along the X-direction may also be open.

That is, the receiving body 219 may include a body bottom side 2194 forming a bottom surface of the receiving space 280, and a first body side 2191 and a second body side 2192 extending from edges (not shown) of the body bottom side 2194 arranged in parallel along the stacking direction toward the receiving cover 211.

The first body side 2191 and the second body side 2192 may have bent end portions forming flanges (not shown), which facilitate coupling with the receiving cover 211.

Referring to FIGS. 1 and 2, a height of the receiving body 219 may be smaller than a height of the plurality of battery cells 110. However, this is merely an example, and the height of the receiving body 219 may be equal to or greater than the height of the plurality of battery cells 110.

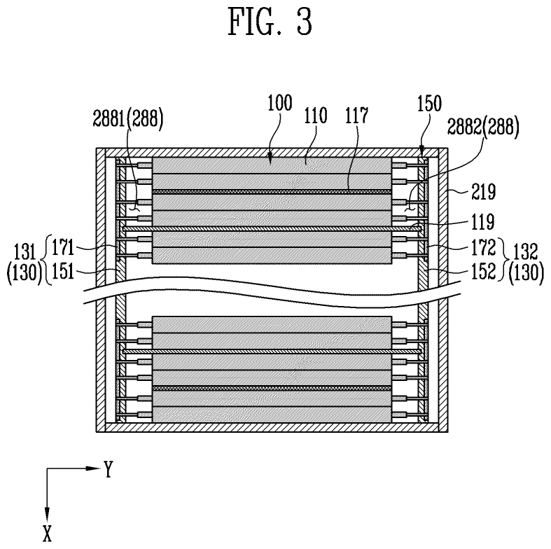

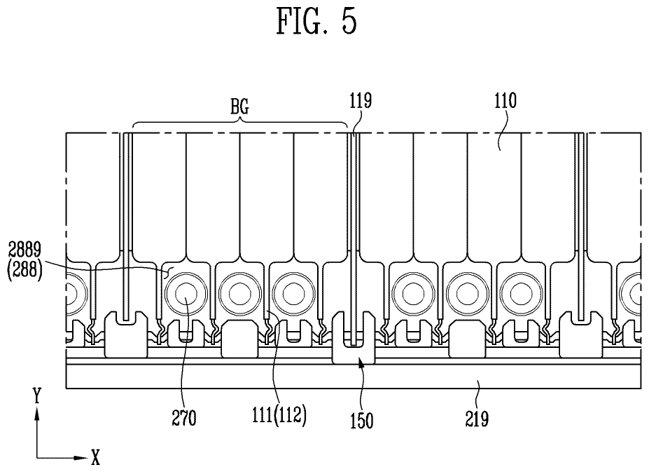

Meanwhile, the battery cell stack 100 may further include a buffer member 117 or a thermal blocking member 119 (see FIG. 3) positioned between the plurality of battery cells 110. The buffer member 117 may be positioned between each of the battery cells 110 or between battery groups BG (see FIG. 5) in which the plurality of battery cells 110 are grouped. The same may apply to the thermal blocking member 119.

The thermal blocking member 119 may serve as a thermal barrier to prevent flame or heat from propagating from a battery cell 110 in which thermal runaway occurs to an adjacent battery cell 110.

The battery cell stack 100 may include at least one buffer member 117. Similarly, the battery cell stack 100 may include at least one thermal blocking member 119. Alternatively, the thermal blocking member 119 may perform both a thermal blocking function and a buffering function at the same time.

For this purpose, the thermal blocking member 119 may be formed in a multilayer structure along the stacking direction of the plurality of battery cells 110. That is, one layer of the multilayer structure may be formed of a flame-retardant (or fire-resistant) material. In addition, another layer of the multilayer structure may serve to reduce pressure exerted on another battery cell 110 when one of the battery cells 110 swells.

The plurality of battery cells 110 and the plurality of thermal blocking members 119 may be alternately disposed between the plurality of battery cells 110. The thermal blocking member 119 may be formed of a fire-resistant (heat-resistant or flame-retardant) material. For example, the thermal blocking member 119 may comprise a fire-resistant polymer or a material such as mica.

Referring to FIG. 2, the battery assembly 200 may further include end plates 212 and 213 provided at both ends of the battery cell stack 100 along the stacking direction. The end plates 212 and 213 may be provided at both ends of the battery cell stack 100 and connected to both side surfaces 2197 and 2198 of the receiving body 219. The end plates 212 and 213 serve to prevent both side surfaces of the battery cell stack 100 from being exposed to the outside.

Accordingly, the end plates 212 and 213 may be disposed at the outermost positions of the plurality of battery cells 110 along the stacking direction (X-direction) of the plurality of battery cells 110.

Meanwhile, the battery assembly 200 may include a busbar 170 electrically connected to the plurality of battery cells 110. The battery assembly 200 may further include a busbar frame 150 configured to support the busbar 170 and the plurality of battery cells 110. As described above, the busbar 170 and the busbar frame 150 may be collectively referred to as a busbar assembly 130 (see FIG. 3).

The busbar assembly 130 may include a first busbar frame 151 and a second busbar frame 152 extending along the stacking direction of the plurality of battery cells 110 with the plurality of battery cells 110 interposed therebetween.

In addition, the busbar assembly 130 may further include a support frame 155 located at one side of the busbar assembly 130 and connecting the first busbar frame 151 and the second busbar frame 152.

The busbar assembly 130 is described in a case where the terminal portions 111 and 112 are respectively located in directions opposite to each other with respect to the cell case 115. Alternatively, when the terminal portions 111 and 112 are located on one side of the cell case 115 and oriented in the same direction, the busbar frame 150 may be positioned on one side (for example, an upper side) of the cell case 115 and electrically connected to the terminal portions 111 and 112.

The support frame 155 may serve to prevent deformation of and support the first busbar frame 151 and the second busbar frame 152. In addition, a part of an electrical device for sensing and controlling the plurality of battery cells 110 may be disposed on the support frame 155.

Referring to FIG. 2, the busbar assembly 130 may have a tunnel shape. The lengths of the first busbar frame 151 and the second busbar frame 152 along the stacking direction may be greater than the length of the support frame 155.

That is, the support frame 155 may be connected to the first busbar frame 151 and the second busbar frame 152 to cover an upper portion of the plurality of battery cells 110. In other words, the support frame 155 may cover not only a part but the entirety of the upper portion of the plurality of battery cells 110.

Referring to FIG. 2, the busbar 170 may include a first busbar 171 supported by the first busbar frame 151 and electrically connected to the first terminal portion 111, and a second busbar 172 supported by the second busbar frame 152 and electrically connected to the second terminal portion 112.

The first busbar 171 and the second busbar 172 may be positioned in directions away from the plurality of battery cells 110 relative to the first busbar frame 151 and the second busbar frame 152, respectively.

That is, the first busbar 171 may be positioned between the plurality of battery cells 110 and the first busbar frame 151, and the second busbar 172 may be positioned between the plurality of battery cells 110 and the second busbar frame 152.

Referring to FIG. 2, the first busbar 171 may contact an outer side of the first busbar frame 151, and the second busbar 172 may contact an outer side of the second busbar frame 152.

The first busbar 171 may be positioned closer to the first body side 2191 than to the first busbar frame 151. Similarly, the second busbar 172 may be positioned closer to the second body side 2192 than to the second busbar frame 152. Accordingly, the first terminal portion 111 and the second terminal portion 112 may be respectively inserted into slit holes (not shown) formed in the first busbar frame 151 and the second busbar frame 152 to be electrically connected to the first busbar 171 and the second busbar 172. However, this is merely an example, and the first terminal portion 111 and the second terminal portion 112 may be electrically connected to the first busbar 171 and the second busbar 172 in other ways as well.

Meanwhile, the battery assembly 200 may further include a heat dissipation portion 295 positioned between the body bottom side 2194 and the plurality of battery cells 110 to transfer heat generated from the plurality of battery cells 110 to the outside of the battery assembly 200.

The heat dissipation portion 295 may be formed of an adhesive material having thermal conductivity, for example, a heat-dissipating adhesive. Accordingly, the plurality of battery cells 110 may be bonded to the body bottom side 2194 through the heat dissipation portion 295. For this purpose, the heat dissipation portion 295 may be sprayed or coated on the body bottom side 2194.

FIG. 3 is a top view of the battery assembly 200 according to the present disclosure.

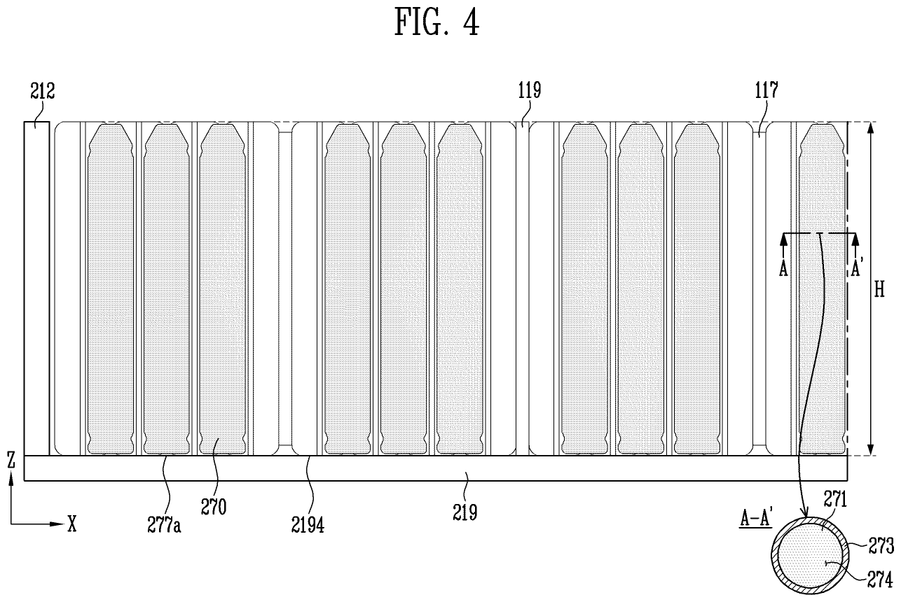

The battery assembly 200 according to the present disclosure may include a plurality of battery cells 110 stacked in a predetermined stacking direction, a receiving case 210 configured to receive the plurality of battery cells 110, an insertion space 288 formed between the plurality of battery cells 110 and the receiving case 210, and a flame-retardant assembly 270 (see FIG. 4) disposed in the insertion space 288.

In one embodiment, the battery assembly 200 according to the present disclosure may further include a busbar 170 electrically connected to the plurality of battery cells 110, and the insertion space 288 may be located between the plurality of battery cells 110 and the busbar 170.

In one embodiment, the battery assembly 200 according to the present disclosure may further include a busbar frame 150 configured to support the busbar 170 between the plurality of battery cells 110 and the busbar 170, and the insertion space 288 may be located between the plurality of battery cells 110 and the busbar frame 150.

The busbar assembly 130 may include a first busbar 171 electrically connected to the first terminal portion 111 and a first busbar frame 151 supporting the first busbar 171. The first busbar 171 and the first busbar frame 151 together may be referred to as a first busbar assembly 131. That is, the first busbar assembly 131 may be electrically connected to the first terminal portion 111 and serve to support the battery cell stack 100.

The busbar assembly 130 may further include a second busbar 172 electrically connected to the second terminal portion 112 and a second busbar frame 152 supporting the second busbar 172. The second busbar 172 and the second busbar frame 152 together may be referred to as a second busbar assembly 132. That is, the second busbar assembly 132 may be electrically connected to the second terminal portion 112 and, together with the first busbar assembly 131, serve to support the battery cell stack 100.

Meanwhile, referring to FIG. 3, the insertion space 288 may be formed between the plurality of battery cells 110 and the busbar assembly 130 due to the electrical connection between the terminal portions 111 and 112 and the busbar assembly 130.

The insertion space 288 may be a part of the receiving space 280 formed inside the receiving case 210. That is, a portion of the receiving space 280 may be a space for receiving the plurality of battery cells 110, and another portion of the receiving space 280 may be a space for the insertion space 288.

Accordingly, the insertion space 288 may be formed between the plurality of battery cells 110 and the receiving case 210.

More specifically, the insertion space 288 is a space formed by the respective cell cases 115 of the plurality of battery cells 110, the respective terminal portions 111 and 112 of the plurality of battery cells 110, and the busbar 170. Typically, when thermal runaway occurs in any one of the plurality of battery cells 110 and off-gas is generated, high-temperature heat may propagate to adjacent battery cells through the insertion space 288.

To prevent such thermal propagation (TP), the battery assembly 200 according to the present disclosure may include a flame-retardant assembly 270 (see FIG. 4) inserted and positioned in the insertion space 288.

Referring to FIGS. 2 and 3, the receiving case 210 may include a body bottom side 2194 forming a bottom surface of the receiving case 210, and a first body side 2191 and a second body side 2192 extending from the body bottom side 2194, disposed to face each other with the plurality of battery cells 110 interposed therebetween along the stacking direction, and forming both side surfaces 2191 and 2192 of the receiving case 210.

The insertion space 288 may include a first insertion space 2881 formed between the plurality of battery cells 110 and the first body side 2191, and a second insertion space 2882 formed between the plurality of battery cells 110 and the second body side 2192.

A plurality of flame-retardant assemblies 270 may be provided, and each of the plurality of flame-retardant assemblies 270 may be positioned in any one of the first insertion space 2881 and the second insertion space 2882.

Meanwhile, referring to FIG. 3, the buffer member 117 or the thermal blocking member 119 may be positioned between the plurality of battery cells 110. The buffer member 117 or the thermal blocking member 119 may be provided between each of the plurality of battery cells 110. Alternatively, the buffer member 117 or the thermal blocking member 119 may be positioned between battery groups BG (see FIG. 5) in which adjacent battery cells 110 are grouped into a predetermined number of groups.

The battery group BG refers to a set of battery cells 110 in which adjacent battery cells 110 among the plurality of battery cells 110 are grouped into a predetermined number of groups. The plurality of battery cells 110 may be grouped into the predetermined number of battery groups BG for achieving a predetermined target voltage or target current, and the battery groups BG may be connected in series or in parallel using the busbar 170.

Referring to FIG. 3, the buffer member 117 and the thermal blocking member 119 are shown as separate members, but the thermal blocking member 119 may also perform the function of the buffer member 117. For this purpose, the thermal blocking member 119 may be a composite material having a plurality of layers with different functions stacked along the stacking direction.

Meanwhile, along the direction from the first busbar frame 151 toward the second busbar frame 152, a length of the thermal blocking member 119 may be greater than a length of the cell case 115. More specifically, the thermal blocking member 119 may contact the first busbar assembly 131 and the second busbar assembly 132. Through this configuration, the thermal blocking member 119 may block or delay the transfer of heat or flames to other locations when thermal runaway occurs in any one of the battery cells 110.

Meanwhile, the first insertion space 2881 may be divided by the first terminal portion 111. Similarly, the second insertion space 2882 may be divided by the second terminal portion 112. However, when the battery cell stack 100 is received in the receiving body 219, lengths of the first terminal portion 111 and the second terminal portion 112 along the height direction of the receiving case 210 or the receiving body 219 are smaller than the height of the battery cell 110, and thus, the first insertion space 2881 and the second insertion space 2882 may communicate with each other.

In addition, the first insertion space 2881 and the second insertion space 2882 may communicate with each other through a space between the plurality of battery cells 110 and the receiving cover 215. Accordingly, the first insertion space 2881 and the second insertion space 2882 may not be completely isolated from each other but may be mutually communicable spaces.

In the present disclosure, the description of the first insertion space 2881 is equally applicable to the second insertion space 2882. Likewise, the description of the insertion space 288 is equally applicable to the first insertion space 2881 and the second insertion space 2882.

FIG. 4 schematically illustrates an example of a flame-retardant assembly 270 received in an insertion space 288.

Specifically, referring to FIG. 4, when the body sides 2191 and 2192 (see FIG. 2) and the busbar assembly 130 (see FIG. 2) are removed and the battery assembly 200 is viewed, a region adjacent to one of the end plates 212 and 213 (see FIG. 2) is illustrated.

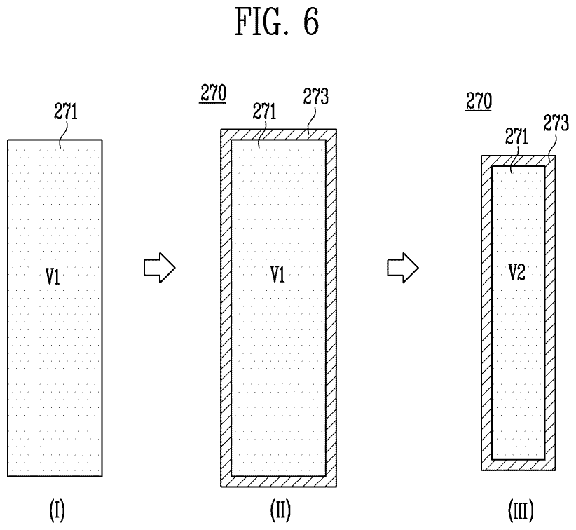

Referring to FIGS. 2 and 4, the battery assembly 200 according to the present disclosure may include a plurality of battery cells 110, a receiving case 210 configured to receive the plurality of battery cells 110, an insertion space 288 formed between the plurality of battery cells 110 and the receiving case 210, and a flame-retardant assembly 270 disposed in the insertion space 288, the flame-retardant assembly 270 including a flame-retardant member 271 comprising an elastic material and formed to have a predetermined first volume V1 (see FIG. 6), and a housing 273 configured to receive the flame-retardant member 271 by compressing the flame-retardant member 271 to a predetermined second volume V2 (see FIG. 6) smaller than the first volume V1.

The flame-retardant assembly 270 (or the flame-retardant assembly for a battery 270) may comprise an elastic material and include a flame-retardant member 271 formed to have a predetermined first volume V1 and a housing 273 configured to receive the flame-retardant member 271 by compressing it to a predetermined second volume V2 smaller than the first volume V1.

The housing 273 forms a refractory space 274 therein and may receive the flame-retardant member 271 by compression within the refractory space 274.

Accordingly, since the flame-retardant member 271 is elastically deformable, when the housing 273 is removed or an external force applied to compress the flame-retardant member 271 is released, the volume of the flame-retardant member 271 may be restored from the second volume V2 to the first volume V1 or may increase to a predetermined third volume greater than the second volume V2.

For example, the flame-retardant member 271 may expand to a third volume greater than the second volume when the housing 273 melts at a predetermined temperature or higher.

The housing 273 may press the flame-retardant member 271 having the first volume to receive it in the second volume.

For example, the housing 273 may include a polymer that melts when reaching a predetermined temperature, and the flame-retardant member 271 may expand to a third volume greater than the second volume when the housing 273 melts at the predetermined temperature or higher.

Specifically, the polymer may be any one selected from polyethylene (PE) and polypropylene (PP), or a combination thereof.

In another example, the housing 273 may be formed of a heat-shrinkable polymer. Specifically, the material of the housing 273 may be any one or a combination of polyolefin capable of thermal shrinkage, polyvinyl chloride (PVC), polytetrafluoroethylene (PTFE), and elastomer.

Alternatively, after the housing 273 receives the flame-retardant member 271 having the first volume V1 therein, the flame-retardant member 271 having the first volume V1 may be transformed into the flame-retardant member 271 having the second volume V2 through a vacuum compression method. For example, the housing 273 may be made of any one or a combination of polyethylene (PE), polypropylene (PP), polyamide (PA), ethylene vinyl alcohol (EVOH), polyethylene terephthalate (PET), or polyvinylidene chloride (PVDC).

The battery cells 110 accommodated inside the battery assembly 200 may generate gas as they repeatedly shrink and expand. Due to the gas, the cell case 115 may expand. At this time, gas generated according to the expansion of the cell case 115 may be trapped between the electrode assemblies 11. This may eventually cause lithium plating (Li-plating) and lead to performance degradation of the battery cell 110.

To prevent swelling of the battery cells 110, it is necessary to suppress expansion of the battery cells 110 within the insertion space 288.

As described above, the flame-retardant assembly 270 according to the present disclosure can suppress the battery cell 110 or the cell case 115 from expanding in the direction in which the terminal portions 111 and 112 protrude, thereby preventing a rapid decrease in the lifespan of the battery cell 110 caused by lithium plating (Li-plating).

Meanwhile, a melting point of the flame-retardant member 271 among the flame-retardant assemblies 270 may be higher than a temperature at which the cell case 115 begins to melt.

For example, the melting point of the flame-retardant member 271 may be higher than an ignition point of the plurality of battery cells 110. The ignition point of the plurality of battery cells 110 may be a temperature at which venting occurs in the battery cell 110.

Accordingly, when thermal runaway starts in any one of the battery cells 110, even if the housing 273 melts and disappears, the flame-retardant member 271 may maintain its solid form.

For example, the flame-retardant assembly 270 may be made of a polymer material having a V-0 rating in the UL (Underwriter's Laboratory) 94V test (Vertical Burning Test), which is a flame-retardant standard for polymer materials.

Alternatively, the flame-retardant assembly 270 may include any one selected from phosphorus-based, halogen-based, and inorganic flame retardants, or a combination thereof.

Meanwhile, referring to FIG. 4, one end of the flame-retardant assembly 270 or the housing 273, which is closer to the receiving cover 215 than to the receiving body 219, may have a tapered shape.

FIG. 5 schematically illustrates another example of a flame-retardant assembly 279 received in an insertion space 288.

Referring to FIG. 5, each of the plurality of battery cells 110 may include an electrode assembly 11, a cell case 115 configured to receive the electrode assembly 11 therein, and terminal portions 111 and 112 electrically connected to the electrode assembly 11 and protruding outward from the cell case 115. The insertion space 288 may be divided into a plurality of separated spaces 2889 by the terminal portions 111 and 112 of the plurality of battery cells 110.

More specifically, referring to FIGS. 2 and 5, the battery assembly 200 according to the present disclosure may further include a busbar frame 150 disposed to face the respective cell cases 115 of the plurality of battery cells 110 along the stacking direction of the plurality of battery cells 110, and a busbar 170 supported by the busbar frame 150 and electrically connected to the terminal portions 111 and 112 of the plurality of battery cells 110 through the busbar frame 150. Each of the plurality of separated spaces 2889 may be formed by the busbar frame 150, the terminal portions 111 and 112, and the respective cell cases 115 of the plurality of battery cells 110.

The insertion space 288 may include the plurality of separated spaces 2889 divided by the terminal portions 111 and 112. However, the terminal portions 111 and 112 do not completely isolate the plurality of separated spaces 2889 from each other. That is, since lengths of the terminal portions 111 and 112 along the height direction of the receiving case 210 are smaller than the height of the receiving space 280, the terminal portions 111 and 112 only partially divide the receiving space 280 along its height direction.

Accordingly, since the lengths of the terminal portions 111 and 112 along the height direction of the receiving case 210 are smaller than the lengths of the respective cell cases 115, the plurality of insertion spaces 288 may be separated by the terminal portions 111 and 112 or may communicate with one another.

Referring to FIGS. 3 and 5, the plurality of first insertion spaces 2881 may be formed by the first terminal portions 111 and may communicate with one another. Similarly, the plurality of second insertion spaces 2882 may be formed by the second terminal portions 112 and may also communicate with one another.

That is, each of the plurality of battery cells 110 may include an electrode assembly 11, a cell case 115 configured to receive the electrode assembly 11 therein, a first terminal portion 111 electrically connected to the electrode assembly 11 and protruding from the cell case 115 toward the first body side 2191, and a second terminal portion 112 electrically connected to the electrode assembly 11 and protruding from the cell case 115 toward the second body side 2192. The first insertion space 2881 and the second insertion space 2882 may be respectively divided into a plurality of separated spaces 2889 by the first terminal portions 111 and the second terminal portions 112 of the plurality of battery cells 110.

In one embodiment, a plurality of flame-retardant assemblies 270 may be provided, and the plurality of flame-retardant assemblies 270 may be disposed in at least a part of the plurality of separated spaces 2889.

Meanwhile, referring to FIG. 5, the battery assembly 200 may further include a thermal blocking member 119 positioned between the plurality of battery cells 110. Alternatively, the battery assembly 200 may further include a thermal blocking member 119 positioned between battery groups BG in which the plurality of battery cells 110 are grouped.

Referring to FIG. 5, the thermal blocking member 119 may be disposed parallel to the plurality of battery cells 110 and may extend to the busbar assembly 130. More specifically, the thermal blocking member 119 may extend to the busbar frame 150 and be inserted into the busbar frame 150. In this case, the flame-retardant assembly 270 may not be inserted into the space where the thermal blocking member 119 is inserted, in order to prevent interference between the flame-retardant assembly 270 and the thermal blocking member 119.

FIG. 6 illustrates a volume change of an example of the flame-retardant assembly 270.

The flame-retardant assembly 270 may include a flame-retardant member 271 whose volume can change under an external force. That is, the volume change of the flame-retardant member 271 may be reversible, and even when compressed up to 90%, it may immediately return to its original first volume when the external force is removed.

Specifically, in step I, the flame-retardant member 271 may be foamed and formed to have a predetermined first volume V1. In step II, the flame-retardant member 271 may be received in the housing 273. In step III, the flame-retardant member 271 may be maintained in a compressed state having a second volume V2 while being received in the housing 273.

For this purpose, the flame-retardant member 271 may be made of a porous material. That is, the flame-retardant member 271 may be a porous material capable of elastic deformation, such as a sponge.

Alternatively, the flame-retardant member 271 may be formed by foaming. For example, the flame-retardant member 271 may be formed of any one selected from a silicone polymer, polyurethane, or epoxy, or a combination thereof.

In addition, to prevent electrical short circuits during thermal runaway, the flame-retardant member 271 may have electrical insulating properties.

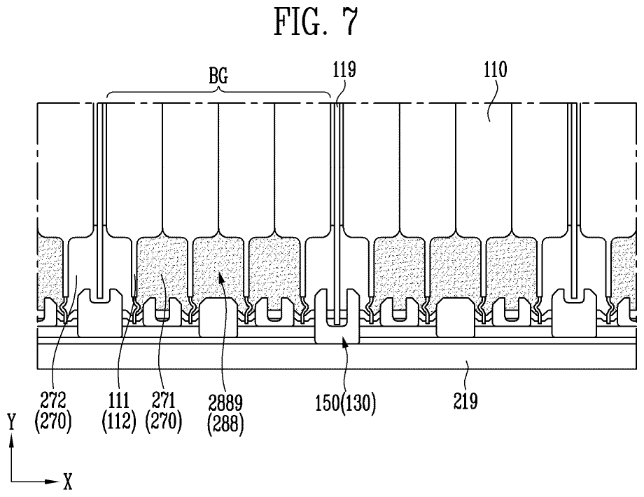

FIG. 7 illustrates a volume change of the flame-retardant assembly 270 received in a separated space 2889 after melting of the housing at a predetermined temperature or higher.

In one embodiment, the flame-retardant member 271 may increase to a third volume greater than the second volume when the housing 273 melts at a predetermined temperature or higher.

That is, referring to FIG. 7, the battery assembly 200 according to the present disclosure may divide the insertion space 288 into the plurality of separated spaces 2889. A plurality of the flame-retardant assemblies 270 may be provided and inserted into at least a part of the plurality of separated spaces 2889.

A volume of the flame-retardant member 271 of any one of the plurality of flame-retardant assemblies 270 may increase to a third volume equal to a volume of any one of the separated spaces 2889 in which the corresponding flame-retardant assembly 270 is disposed, when the housing 273 of the corresponding flame-retardant assembly 270 melts at a predetermined temperature or higher.

That is, as the housing 273 melts and is removed at a predetermined temperature or higher, the flame-retardant member 271 may be transformed from the second volume to a third volume greater than the second volume and equal to or less than the first volume.

For example, the first volume V1 may be the volume of the flame-retardant member 271 before it is received in the housing 273 after foaming. In addition, the first volume may be equal to or greater than the volume of any one of the separated spaces 2889.

The second volume V2 may be the volume of the flame-retardant member 271 when compressed after being received in the housing 273. That is, under normal operation of the battery assembly 200, the volume of the flame-retardant member 271 may correspond to the second volume V2.

The third volume may correspond to the volume of one separated space 2889 into which the flame-retardant assembly 270 is inserted. Accordingly, the third volume may be greater than the second volume and equal to or less than the first volume.

As the compressed flame-retardant member 271 expands to the third volume, the flame-retardant member 271 may fill the separated space 2889 in which it is located. Through this, the flame-retardant assembly 270 or the flame-retardant member 271 may maximally fill the separated space 2889.

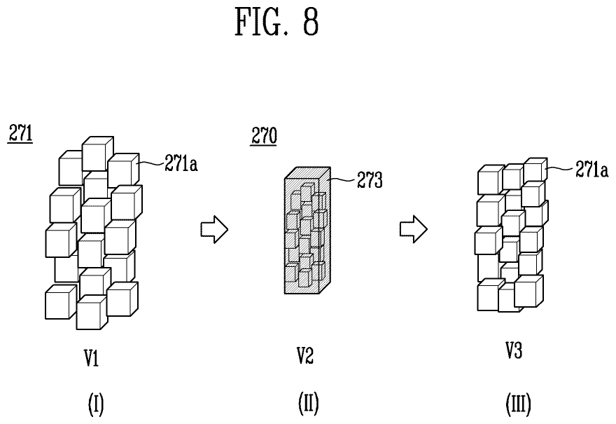

FIG. 8 illustrates a volume change of another example of the flame-retardant assembly.

The flame-retardant member 271 may include a plurality of flame-retardant bodies 271a, and a total volume of the plurality of flame-retardant bodies 271a may be compressed to the second volume V2 by the housing 273 and received in the housing 273.

The flame-retardant member 271 of FIG. 6 may be integrally formed to have the first volume V1, while the flame-retardant member 271 of FIG. 7 may have a stacked structure including the plurality of flame-retardant bodies 271a. Since the plurality of flame-retardant bodies 271a are not bound together by a binder and are individually movable, the flame-retardant member 271 may include air gaps between the plurality of flame-retardant bodies 271a.

Although each of the plurality of flame-retardant bodies 271a may have a small individual volume, a total volume of the plurality of flame-retardant bodies 271a may correspond to the first volume V1. In step I, the plurality of flame-retardant bodies 271a are stacked so that their total volume corresponds to the first volume V1, and in step II, the plurality of flame-retardant bodies 271a are packaged by the housing 273 and compressed from the first volume V1 to a predetermined second volume V2.

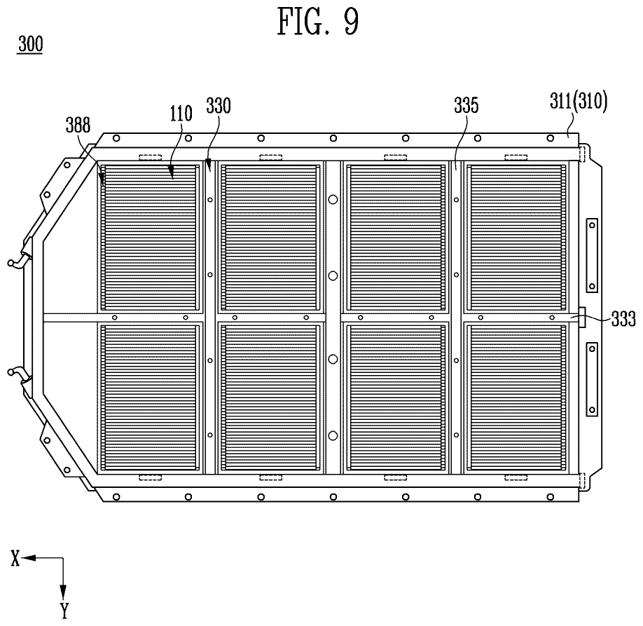

Subsequently, when an event (for example, thermal runaway) occurs in the battery assembly 200 (see FIG. 1) or 300 (see FIG. 9) containing the plurality of flame-retardant bodies 271a, and the housing 273 melts, the total volume of the plurality of flame-retardant bodies 271a may increase to a third volume V3, which is greater than the second volume V2 and equal to or less than the first volume V1, as shown in step III.

FIG. 9 illustrates another example of the battery assembly 300 according to the present disclosure.

FIG. 9 illustrates another example of a battery assembly 300 provided in the form of a battery pack. That is, the battery assembly 300 may have a cell-to-pack (CTP) structure in which a plurality of battery cells 110 are directly accommodated in the form of a pack without a separate battery module.

The battery assembly 300 may include a plurality of battery cells 110 stacked and arranged in a predetermined stacking direction, a receiving case 310 configured to receive the plurality of battery cells 110, an insertion space 388 formed between the plurality of battery cells 110 and the receiving case 310 along the stacking direction, and a flame-retardant assembly (not shown) positioned in the insertion space 388.

The receiving case 310 may include a receiving body 311 configured to receive the plurality of battery cells 110, and a receiving cover (not shown) coupled to the receiving body 311.

In addition, the receiving case 310 may further include a partition portion 330 configured to separate the plurality of battery cells 110 into a plurality of groups.

The partition portion 330 may further include a first frame 333 and a second frame 335 configured to partition the plurality of battery cells 110 in horizontal and vertical directions, respectively. The first frame 333 and the second frame 335 not only prevent deformation of the receiving body 311 but also serve to support and separate the plurality of battery cells 110. Furthermore, the flame-retardant assembly may also be positioned between the plurality of battery cells 110 and the partition portion 330.

The present disclosure may be embodied in various forms and is not limited to the above-described embodiments. Therefore, any modified embodiments that include the constituent elements of the claims of the present disclosure should be understood as falling within the scope of the present disclosure.

What is claimed is:

1. A flame-retardant assembly for a battery, comprising:
a flame-retardant member comprising an elastic material and formed to have a first volume; and
a housing configured to receive the flame-retardant member by compressing the flame-retardant member to a second volume smaller than the first volume.

2. The flame-retardant assembly for a battery according to claim 1, wherein the flame-retardant member increases to a third volume greater than the second volume when the housing is melted at a predetermined temperature or higher.

3. The flame-retardant assembly for a battery according to claim 2, wherein the housing comprises a heat-shrinkable polymer.

4. The flame-retardant assembly for a battery according to claim 1, wherein the flame-retardant member comprises any one selected from a silicone polymer, polyurethane, or epoxy, or a combination thereof.

5. The flame-retardant assembly for a battery according to claim 1, wherein the flame-retardant member comprises a plurality of flame-retardant bodies, and a total volume of the plurality of flame-retardant bodies is compressed to be equal to or less than the second volume by the housing and received in the housing.

6. A battery assembly comprising:
a plurality of battery cells;
a receiving case configured to receive the plurality of battery cells;
an insertion space formed between the plurality of battery cells and the receiving case; and
a flame-retardant assembly disposed in the insertion space,
wherein the flame-retardant assembly comprises a flame-retardant member comprising an elastic material and formed to have a first volume, and a housing configured to receive the flame-retardant member by compressing the flame-retardant member to a second volume smaller than the first volume.

7. The battery assembly according to claim 6, wherein the flame-retardant member increases to a third volume greater than the second volume when the housing is melted at a predetermined temperature or higher.

8. The battery assembly according to claim 6, further comprising a busbar electrically connected to the plurality of battery cells,
wherein the insertion space is located between the plurality of battery cells and the busbar.

9. The battery assembly according to claim 8, further comprising a busbar frame configured to support the busbar between the plurality of battery cells and the busbar,
wherein the insertion space is located between the plurality of battery cells and the busbar frame.

10. The battery assembly according to claim 6, wherein each of the plurality of battery cells comprises:
an electrode assembly;
a cell case configured to receive the electrode assembly therein; and
a terminal portion electrically connected to the electrode assembly and protruding outward from the cell case,
and wherein the insertion space is divided into a plurality of separated spaces by the terminal portions of the plurality of battery cells.

11. The battery assembly according to claim 10, further comprising:
a busbar frame disposed to face the respective cell cases of the plurality of battery cells along a stacking direction of the plurality of battery cells; and
a busbar supported by the busbar frame and electrically connected to the respective terminal portions of the plurality of battery cells through the busbar frame,
wherein each of the plurality of separated spaces is formed by the busbar frame, the respective terminal portions, and the respective cell cases of the plurality of battery cells.

12. The battery assembly according to claim 10, wherein a plurality of the flame-retardant assemblies are provided, and the plurality of flame-retardant assemblies are disposed in at least a part of the plurality of separated spaces.

13. The battery assembly according to claim 12, wherein a flame-retardant member of any one of the plurality of flame-retardant assemblies increases to a third volume equal to or less than a volume of any one of the separated spaces in which the corresponding flame-retardant assembly is disposed when a housing of the corresponding flame-retardant assembly is melted at a predetermined temperature or higher.

14. The battery assembly according to claim 6, wherein the receiving case comprises:
a body bottom side forming a bottom surface of the receiving case; and
a first body side and a second body side connected to the body bottom side, disposed to face each other with the plurality of battery cells interposed therebetween along a stacking direction of the plurality of battery cells, and forming both side surfaces of the receiving case,
and wherein the insertion space comprises:
a first insertion space formed between the plurality of battery cells and the first body side; and
a second insertion space formed between the plurality of battery cells and the second body side.

15. The battery assembly according to claim 14, wherein each of the plurality of battery cells comprises:
an electrode assembly;
a cell case configured to receive the electrode assembly therein;
a first terminal portion electrically connected to the electrode assembly and protruding from the cell case toward the first body side; and
a second terminal portion electrically connected to the electrode assembly and protruding from the cell case toward the second body side,
and wherein the first insertion space and the second insertion space are respectively divided into a plurality of separated spaces by the first terminal portions and the second terminal portions of the plurality of battery cells.
